(19) United States
(12) Patent Application Publication
(10) Pub. No.: US 2018/0249807 A1
(43) Pub. Date: Sep. 6, 2018

(54) ROTATIVE PROCESS OF COSMETIC SAMPLE PRODUCTION, COSMETIC SAMPLES AND AUTOMATIC COSMETIC SAMPLE APPLICATION

(71) Applicant: ADHESPACK INDÚSTRIA, COMÉRCIO, IMPORTAÇÃO E EXPORTAÇÃO LTDA, São Paulo (BR)

(72) Inventor: Volney Olivato DE CAMARGO, São Paulo (BR)

(73) Assignee: ADHESPACK INDUSTRIA,COMERCIO, IMPORTACAO E EXPORTACAO LTDA

(21) Appl. No.: 15/760,559

(22) PCT Filed: Sep. 16, 2016
(86) PCT No.: PCT/BR2016/000094

§ 371 Date: Mar. 15, 2018

(30) Foreign Application Priority Data
Sep. 16, 2015 (BR) BR 10 20150238193

(51) Int. Cl. A45D 40/00; B65D 75/30; A45D 37/00; G09F 5/04

(52) U.S. Cl. CPC A45D 40/0087; G09F 5/04; A45D 37/00; B65D 75/30

(57) ABSTRACT

It is described a rotative process of cosmetic sample (40) production, particularly used for automatic sample (40) application in magazines, catalogues or showcase cards. It is also described a cosmetic sample (40) produced in sample reels (31) through rotative process of cosmetic sample production and endowed with a second surface (45) containing adhesive material (46) for automatic applications on surfaces. At last it is described an automatic sample application (40) on surfaces (70), increasing substantiality productivity, application quality and hygiene when manipulating samples (40).

The present invention refers to a rotative process of cosmetic sample production, specifically used to automatic cosmetic sample application in magazines and catalogues. This invention also refers to cosmetic samples, produced in reels through rotative process of cosmetic sample production and equipped with an adhesive surface for the automatic application in other surfaces and the automatic sample application in these surfaces.

### DESCRIPTION OF THE PRIOR ART

A sample is an opportunity for the user or client to know the product before acquiring it or to certify if the client really wants to get the product. Through samples it is possible to feel cosmetic tonality in the skin and decide the products to be bought quite sure that is the desired product or the product of interest.

Providing of single samples of a cosmetic avoids an old need to provide a flask of product to serve as a showcase, preventing their sale.

Direct sales by ordering products showed in catalogues have demanded that the products offeror allows the clients to try and to know the cosmetics tonality that are offered. This demand was supplied with the spare samples of products offered by sellers and representatives.

The development of this kind of samples is intense because it is increasingly desired that the consumer can try, from a small quantity, all sensorial effects that the product offer.

In this regard, it is possible to mention document U.S. Pat. No. 4,751,934 that refers to a cosmetic sample produced from a cosmetic portion application over a paper base layer. On this paper base it is possible to exist prints of drawing over which the cosmetic material is applied. A protective film is applied over the cosmetic to protect the material until the sample is used.

Document PI 9913811-5 makes reference to an unit dose cosmetic sample applicator in which some cosmetic portion is applied under a base film and a protective film protects the cosmetic until the sample is used.

Document US 2006/0021632 describes a cosmetic applicator, preferably lipsticks. This applicator consists in an unique card that contain a small quantity of lipstick for sample. In the card the mouth format is designed and the lipstick sample is filed over the drawing. Between the upper lip and lower lip design there is a fold line. The applicator must be folded in half in this line in such a way that the lips drawings stay outward. So by nuzzling the mouth at the applicator, the lips touch the drawings and the lipstick is applied.

Document US 2010/0218783 also refers to a cosmetic applicator. This applicator has an elliptic form and the cosmetic is filed beside the ellipse major axis keeping one portion of the paper base without cosmetic. This portion without cosmetic is folded in order to form a holder area to apply cosmetic directly from de sample to the skin, for example, to pass the applicator in eyelid if the cosmetic applied in the sample is an eye makeup, without the need of first passing the finger in the sample so after apply it in the face.

Although above-mentioned prior art documents refer to sampler or cosmetic samples that provide the consumers the possibility of trying a product before acquiring it, the described samples are not adhesive and, mainly, none of these documents describes samples fabrication through a rotative process, i.e., the samples described and already known are produced by plane processes in which samples are made over a plane paper strip base and subsequently cut in predetermined sizes. Thus, to be applied in showcases cards or in catalogues it is necessary that the samples receive a glue layer in the external portion of the paper base and be glued above the desired magazine, catalogue, etc. It makes the automation of this process more difficult and expensive.

### OBJECTIVES OF THE INVENTION

The objective of the present invention is to provide a rotative process of cosmetic sample production that is able to produce samples in reels, making possible the automatic sample application in magazines, catalogues or showcase cards.

Another objective of this invention is to provide adhesive cosmetic samples susceptible of been produced in reels in such a way as to be automatically applied in catalogues, magazines or showcase cards.

It's also an objective of this invention to provide an automatic application of adhesive samples in the surfaces of interest from adhesive samples produced in reels.

### BRIEF DESCRIPTION OF THE INVENTION

The present invention has as object a rotative process of cosmetic sample production including the following steps:

a) Placement of a flat reel of base tape in a feeder roll;

b) Fixing a free edge of the base tape in a receptor roll; and

c) Application of a plurality of cosmetic samples over the base tape, while base tape is transferred from feeder roll to roll shaping an samples reel.

Another object of this invention is a cosmetic samples comprising a lower surface that contains a first surface over which it is applied an amount of cosmetic and an adhesive trail close to the edges of the lower surface and running round the perimeter of this lower surface, the lower surface comprising a second surface opposite to the surface that contains the amount of cosmetic and in which an adhesive material is applied.

The present invention has also as an object an automatic sample application over surfaces, comprising a base tape equipped with a plurality of cosmetic samples passing over a flate-plate and rounding an edge of this flate-plate so the sample gets out of the base tape.

### BRIEF DESCRIPTION OF THE DRAWINGS

The present invention will be described detail in the following, based on an example of practice that is represented in the drawings. The Figures show the following:

FIG. 1—is a flowchart of the rotating process of process of cosmetic sample production object of this invention;

FIG. 2A—is a schematic perspective view of the adhesive samples object of the present invention;

FIG. 2B—is a lower view of the sample illustrated in FIG. 2A;

FIG. 3—is a schematic view of adhesive cosmetic samples produced in reels by rotative production process that are objects of the present invention; and

FIG. 4—is a schematic view of the automatic application of adhesive cosmetic samples in surfaces of catalogues, magazines, cards, among others.

### DETAILED DESCRIPTION OF THE INVENTION

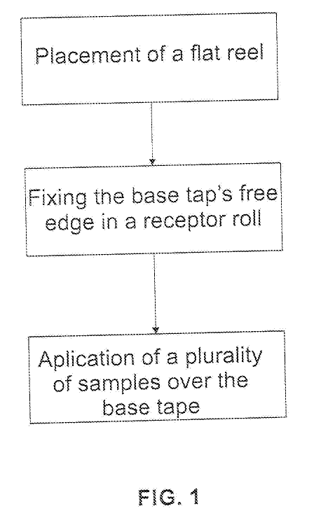

According to a preferable embodiment and as it can be seen in FIGS. 1 to 4, the present invention refers to a rotative process of cosmetic adhesive sample production, to adhesive samples themselves and to an automatic sample application in magazines, catalogues, cards, among others.

FIG. 1 illustrates the flowchart of the main steps of the sample producing process in reels, which steps are:

a) Placement in a feeder roll of a flat reel 30 of base tape 20;

b) Fixing a free edge of the base tape 20 in a receptor roll; and

c) Application of a plurality of cosmetic samples 40 over the base tape 20, while base tape 20 is transferred from feeder roll 50 to roll 51 shaping the adhesive samples reel 31.

The process to produce sample in reels, object of the present invention, is a rotative process, i.e., a process in which the material gets out of a reel, receives samples and so is rewound at the end of the sample applications.

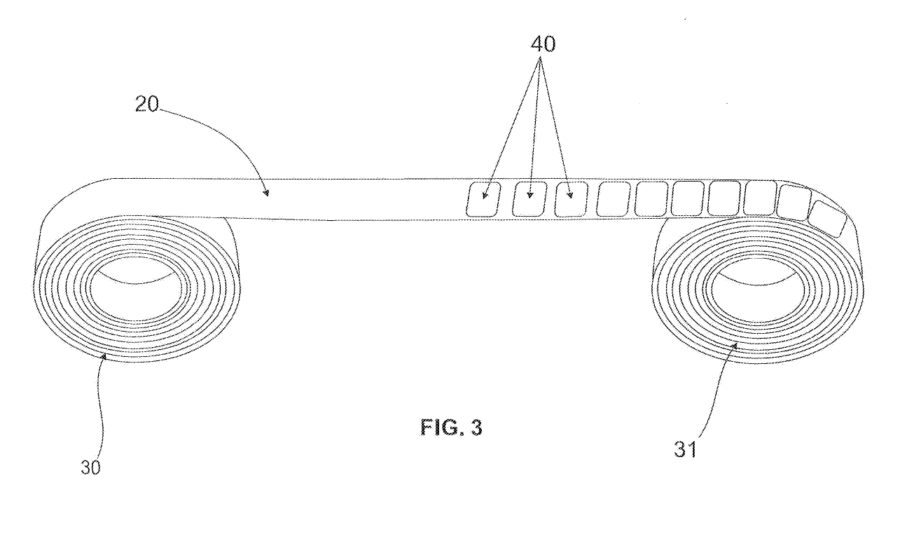

Therefore, a flat reel 30 (FIG. 3) formed by base tape 20, that can be made of polymeric film or silicone paper, is positioned in the feeder roll (not illustrated), i.e., in the roll from which base tape 20 will be uncoiled to receive the plurality of cosmetic samples 40.

The free edge of the base tape 20 is then pulled and fixed in the receptor roll (not illustrated), that is, the roll in which base tape 20 containing a plurality of samples 40 applied will be coiled (FIG. 3).

During the transference of the base tape 20 from the flat reel 30 in the feeder roll to the receptor roll is made the application of a plurality of adhesive cosmetic samples 40 over the base tape 20. The transference speed of the base tape 20 from feeder to receptor roll is constant and the application of the plurality of cosmetic samples 40 on base tape 20 is automated and made by conventional machines that are already known in prior art.

The plurality of adhesive cosmetic samples 40 is disposed on the base tape 20 maintaining a constant distance E between consecutive samples 40. This distance E is important to allow the automatic application of the samples 40 in surfaces as catalogues, magazines, etc., as it will be described forward.

After finishing the transference of base tape 20 to the receptor roll it is also finished the sample 40 application on this base tape 20 and, thus, it is formed the sample reel 31 (FIG. 3), which will be used in the automatic application of sample 40 in surfaces.

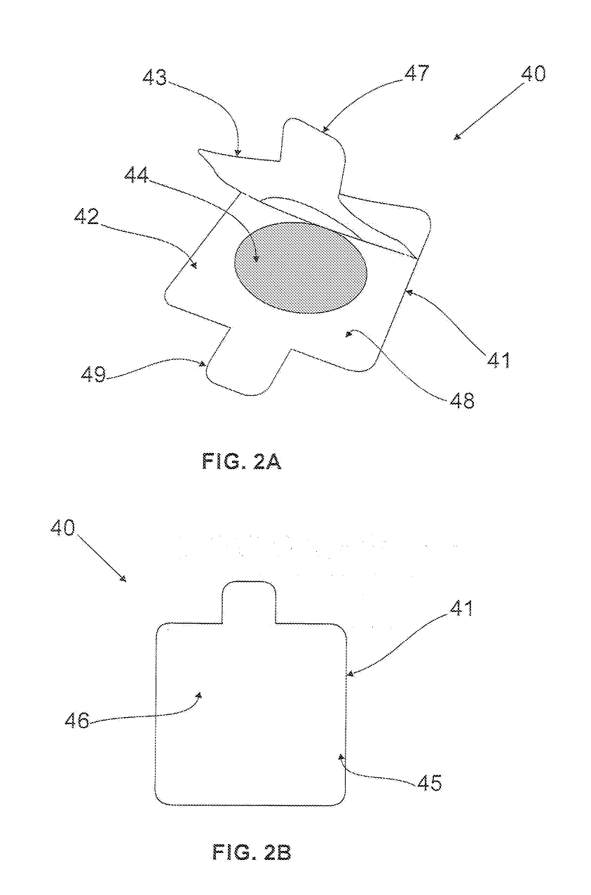

As can be seen in FIG. 2A, the cosmetic sample 40, that is also object of the present invention, comprises a lower film 41 made of polymeric material, endowed with of a first surface 48 over which is applied an amount of cosmetic 44 and an adhesive trail 42. The amount of cosmetic 44 is filed in a delimited region, with defined form or not, preferably the central region of the first surface 48 and the adhesive trial 42 is applied close to the edges of the lower film 41 and countering lower film's 41 perimeter.

The lower film 41 can also comprise a first holder region 49 which function is to help the removal of an upper film 43 which is placed above the amount of cosmetic 22 and above the adhesive trial 42.

This upper film 43 is also made of polymeric material and comprises a second holder region 47 which is coincident with the first holder area 49 of lower film 41 when the upper film 43 is positioned over the first surface 48 of lower film 41, in order to make the upper film's 43 removal easier by the user, exposing the amount of cosmetic of the cosmetic sample 40. In this sense, the upper film 43 function is to protect the amount of cosmetic quantity 44 until the cosmetic sample is used. Further, it is possible that the upper film 43 has decorative print with transparent space that allows the users to observe what kind of cosmetic the sample has, the color and the consistence (liquid, pasty or powder) of this cosmetic or region of lower film 41 on which the cosmetic is applied.

In relation to cosmetic sample 40 and according to FIG. 2B, the lower film 41 also comprises a second surface 45, opposite to the first surface 48 that contains the amount of cosmetic 44, and this second surface 45 comprises an adhesive material 46 that can cover the totality of second surface 45 or some random or predetermined regions of this second surface 45.

The adhesive material 46 on the second surface 45 of lower film 41 does not have a protective and individual film, that is, one for each sample 40. This adhesive material 46 is protected directly by the base tape 20 when sample 40 is applied over the base tape 20. This characteristic together with the fact of the samples 40 be provided through a sample reel 31 allow the automatic application of the sample 40 in any surface of interest as for example, magazine, catalogues, showcase cards, among others.

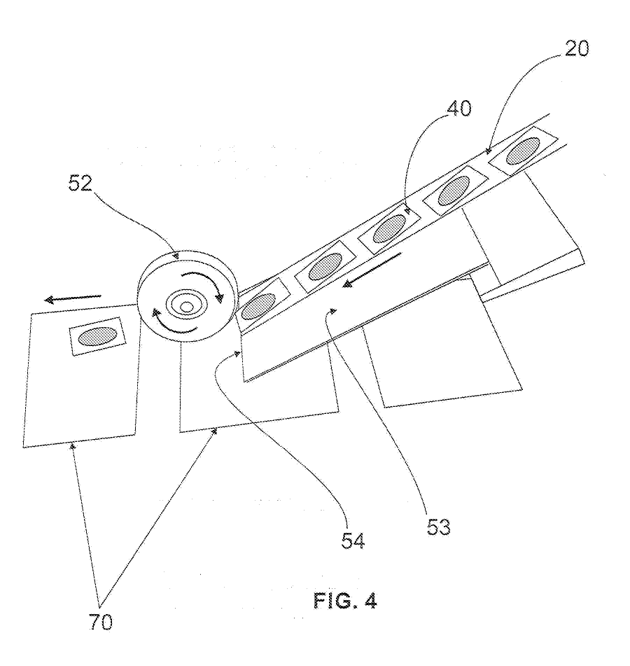

According to FIG. 4 the present invention has as object an automatic cosmetic sample 40 application on a surface 70.

This automatic applications comprises the disposal of the base tape 20 endowed with a plurality of samples 40 taken by sample reel 31 and disposed stretched over a flat-plate 53 and folded around a flat-plate's edge 54, forming an angle of 90° for making possible the separation of the sample 40 from the base tape 20. An edge of the base tape 20 is hitched to an axis (not illustrated) that will coil base tape 20 after the sample 40 is applied. This way, the upper portion of the flat-plate 53 passes the base tape 20 with samples 40 and in the lower portion of flat-plate 53 the base tape 20 passes without samples (not illustrated).

The surfaces 70, which can be magazines, catalogues or sample cards are positioned over a flat belt (not illustrated) so the region in which the sample 40 should be fixed is precisely positioned to receive it. The base tape 20 with the samples 40 is positioned on the flat-plate 53 and its free edge is fixed to an axis.

The flat belt moves the surfaces 70 in a constant speed. When surface 70 passes through the application point of the sample 40 the base tape 20 is also moved in a constant speed, passing by flat-plate 53 and folded on the edge 54 of this flat-plate 53 in order to release sample 40 and adhere it to surface 70 at the exact and desired place. A roller 52 in constant rotation passes over the sample 40 as soon this sample 40 is disposal on the surface 70 applying pressure on this sample 40 and ensuring the correct glue without bends or boils.

The movements of the surfaces 70, base tape 20 and roller 52 are all synchronized so the sample 40 gets out of the base and is glued in the exact place on the surface 70 in a constant way, automated and with acceptable reliability.

In function of the adhesive material 46 present in the second surface 45 of the sample 40, when the sample 40 is transferred to surface 70 it is automatic glued on the surface 70, without the need of any other manual steps after this automatic application.

Therefore, the automatization on either sample reel 31 production or on the automatic sample 40 application on surface 70 provides a substantial increase in quality and productivity, besides security and health, because cosmetic does not has contact with air after it is applied on sample 40 and there is no manual contact that can contaminate samples. In addiction, sample 40 containing adhesive predicts freedom to its application wherever the user wants, only by taking a sample directly from the sample reel 31 and fixing it in the desire surface 70, automatically or manually.

Another vantage of this invention is in the fact that the cosmetic is not shared. When a flask or product unit is available as showcase, there is no hygiene once several people touch skin or moth with the showcase in order to try the cosmetic. Using these samples 40 in a single sterile dose, that is, without contamination in the manufacturing process of the samples 40, hygiene is ensured and prevents health risks to users.

Although only one preferred example of realization has been described, it should be understood that the scope of the instant invention comprehends other possible variations and that it is limited only by the content of the attached claims, including therein the possible equivalents hereof.

1-10. (canceled)

11. A cosmetic sample (40) comprising a lower film (41) having a first surface (48) over which an amount of cosmetic (44) is applied and an adhesive trial (42) close to the extremities of the lower film (41) and running round the perimeter of this lower film (41), the cosmetic sample (40) being characterized by the fact that the lower film (41) comprises a second surface (45) opposite to the surface that contains the amount of cosmetic (44) and on which adhesive material (46) is applied.

12. The cosmetic sample, according to claim 11, characterized by the fact that comprises an upper film (43) arranged over the amount of cosmetic (44) and over the adhesive trial (42).

13. An automatic sample application (40) in a surface (70), characterized by the fact that comprises a base tape (20) endowed with a plurality of cosmetic sample (40) passing over a flat-plate (53) and around of an edge (54) of this flat-plate (53) so the sample (40) gets out of the base tape (20) to be transferred from base tape (20) to surface (70) at the same time the gluing of the adhesive sample on this surface occurs.

14. The automatic sample application (40) in a surface (70), according to claim 13, characterized by the fact that the surface (70) is magazines, catalogues or showcase card.
